(19) United States
(12) Patent Application Publication
(10) Pub. No.: US 2012/0068951 A1
(43) Pub. Date: Mar. 22, 2012

(54) DYNAMIC DOOR DISPLAY SYSTEM AND METHOD

(75) Inventor: Sathya Vagheeswar Venkatasubramanian, Pittsburgh, PA (US)

(73) Assignee: Bombardier Transportation GmbH, Berlin (DE)

(21) Appl. No.: 13/235,022

(22) Filed: Sep. 16, 2011

Related U.S. Application Data
(60) Provisional application No. 61/448,820, filed on Mar. 3, 2011.
(60) Provisional application No. 61/384,473, filed on Sep. 20, 2010.

(51) Int. Cl. G06F 3/041; G03B 21/14

(52) U.S. Cl. 345/173; 353/13; 353/121

(57) ABSTRACT

In a system and method of image display, an image projector is positioned to back project (or rear project) an image on one or more platform doors disposed between a passenger platform of a train or people mover station and a pathway of the train or people mover. The image projector is positioned on the pathway side of the one or more platform doors. The image projector back projects the image on the one or more platform doors such that the image is diffusedly transmitted through them for observation by passengers on the platform side of the station. The back projected image is oriented such that characters or words in the image have a proper left-to-right, or right-to-left, orientation for reading by passengers on the platform side of the station.

### CROSS REFERENCE TO RELATED APPLICATIONS

The present application claims priority from U.S. Provisional Patent Application Nos. 61/384,473, filed Sep. 20, 2010, and 61/448,820, filed Mar. 3, 2011, both of which are incorporated herein by reference.

### BACKGROUND OF THE INVENTION

1. Field of the Invention

The present invention is directed to communication systems and, more particularly, to a method of passive or interactive communication with passengers of a train or people mover.

2. Description of Related Art

In almost every major airport around the world, passengers are found to anxiously shuttle between terminal gates, and sometimes between airport terminals in order to get to their destinations. Thanks to affordable air travel, there are a lot more passengers travelling by air today than a decade ago. With the affordability comes congestion, long queues at check in counters, security checks, ground transportation, at food courts and even while boarding the airplane.

While transiting between flights at major airports, passengers typically use a ground transportation mode. These may be an automated people mover (APM), such as the BOMBARDIER INNOVIA APM or an escalator or even an elevator. Despite the presence of these various modes of transportation, passengers are still nervous about getting to their next terminal gate to board their next flight.

There is a need to ease the experience of the travelling passenger in order to reduce stress, to make their transit more comfortable and to help them make better use of their time in between their connections.

### SUMMARY OF THE INVENTION

In accordance with one embodiment, the invention combines an interactive touchscreen system with platform doors to allow passengers to perform an electronic transaction. Such an allowance creates a highly satisfactory passenger experience and facilitates smooth transition in airports, for example. Other places likely to benefit from the invention include train stations and bus terminus.

In accordance with another embodiment, the invention combines an interactive touchscreen with a rear projection system on a platform door to allow passengers to perform an electronic transaction. Such transactions may involve monetary or non-monetary modes. In one example, the transaction may involve a passenger at a first station ordering a beverage from a vendor located near a second station where the passenger is expected/required to travel to. Based on the travel time, the train schedule and/or an expected time for pick up of the beverage, a business transaction system will process and queue the transaction at the vendor-side for preparation. The goal of the transaction is to ensure that when the passenger arrives at the vendor to pick up the beverage, it is prepared fresh and ready for consumption.

In accordance with another embodiment, the invention involves providing means to allow information to be provided back to a passenger based on request by the passenger. In one example, the information (which may be an airport terminal map with directions between an origin and a destination point) may be printed. In another example, the information may be transmitted wirelessly to the passenger to his/her mobile phone. In another example, the information may simply be projected on the display portion of the platform door for mental capture by the passenger.

The invention is a method of image display on one or more platform doors of a passenger platform of a train or people mover station. The method includes: (a) providing an image projector positioned to project a first image on one or more platform doors disposed between a passenger platform of a train or people mover station and a pathway of the train or people mover, wherein the image projector is positioned on the pathway side of the one or more platform doors; and (b) causing the image projector to back project the first image on the one or more platform doors.

At least a part of each platform door where the first image is back projected can be clear, opaque, or include a film that is switchable between clear and opaque.

The first image can either be a single image or one image of plurality of images, e.g., such as a slide presentation or a movie.

Step (a) can include positioning the image projector such that movement of the train or people mover on the pathway between the image projector and the one or more platform doors blocks the back projection of the first image on the one or more platform doors.

The method can further include synchronizing the image projector to a location of the train or people mover relative to the station, whereupon: the image projector back projects the first image on the one or more platform doors when the train or people mover is located remote from the station; and the image projector withholds back projecting the first image when the train or people mover is located at the station.

Step (b) can include the image projector back projecting the first image in the absence of the train or people mover at the station. The method can further include (c) in response to movement of the train or people mover toward the station, terminating the image projector back projecting the first image; and (d) in response to movement of the train or people mover away from the station, commencing the image projector back projecting either the first image or a second image on the one or more platform doors.

The method can further include: (c) providing at least one of the one or more platform doors with touchscreen capability; (d) via the touchscreen capability, detecting the presence and location of a touch on the platform door within a specified area of the first image back projected on the platform door; and (e) executing software code related to the location of the touch in step (d).

The touchscreen capability can include: the platform door including a circuit configured to generate an output related to a location of the touch on the platform door; and a controller responsive to the output of the circuit in response to the touch for correlating the location of the touch on the platform door to the specified area of the image displayed on the platform door.

The circuit can be implemented utilizing one of the following touchscreen technologies: capacitive, resistive, surface acoustic wave, strain gauge, piezoelectric, and dispersive signal.

Also or alternatively, the touchscreen capability can include: light emitters and light receivers operatively positioned about the platform door to form a light detection grid above a surface of the platform door; and a controller programmed to be responsive to a change in light received by at least one light receiver in response to the touch for correlating the location of the touch on the platform door to the specified area of the image displayed on the platform door.

The light emitters can output infrared light and the light receivers can be infrared light receivers.

The invention is also a method of image display on a platform door that separates a passenger platform of a train or people mover station from a pathway of the train or people mover. The method includes: (a) positioning an image projector to project an image toward a platform door disposed between a passenger platform of a train or people mover station and a pathway of the train or people mover, wherein the image projector is positioned on the pathway side of the platform door; (b) coupling to the image projector a controller (such as a PC) that is programmed to cause the image projector to back project the image toward the platform door; and (c) providing an input to the controller which is responsive to a signal produced via the input for executing the program to cause the image projector to back project the image toward the platform door.

At least a part of each platform door where the image is back projected toward is clear, opaque, or includes a film that is electronically switchable between clear and opaque.

In step (a), the image projector is positioned such that movement of the train or people mover on the pathway between the image projector and the platform door causes the back projected image to fall on the train or people mover.

The method can further include synchronizing the image projector to a location of the train or people mover relative to the station, whereupon: the image projector back projects the image on the platform door when the train or people mover is located remote from the station; and the image projector withholds back projecting the image when the train or people mover is located at the station.

The method can further include: (d) providing the platform door with touchscreen capability; (e) via the touchscreen capability, detecting the presence and location of a touch on the platform door within a specified area of the image back projected on the platform door; and (f) executing software code related to the location of the touch in step (e).

The touchscreen capability can include: the platform door including a circuit operative for generating an output related to a location of the touch on the platform door; and a controller responsive to the output of the circuit in response to the touch for correlating the location of the touch on the platform door to the specified area of the image displayed on the platform door.

Also or alternatively, the touchscreen capability can include: light emitters and light receivers operatively positioned about the platform door to form a light detection grid above the surface of the platform door; and the controller programmed to be responsive to a change in light received by at least one light receiver in response to the touch for correlating the location of the touch on the platform door to the specified area of the image displayed on the platform door.

The invention is also an image display system comprising, in combination: a platform door separating a passenger platform of a train or people mover station from a pathway of the train or people mover; an image projector positioned on the pathway side of the platform door to project an image toward the platform door; and a controller programmed to cause the image projector to back project the image toward the platform door.

The controller can be responsive to an input signal for executing the program to cause the image projector to back project the image toward the platform door.

At least a part of each platform door where the image is back projected toward can be clear, opaque, or switchable between clear and opaque.

The image projector can be positioned such that movement of the train or people mover on the pathway between the image projector and the platform door blocks the back projection of the image on the platform door.

A presence sensor can be coupled to the controller and operatively positioned to detect the presence or absence of the train or people mover at the station. The controller can be response to an output of the presence sensor for causing the image projector to (1) back project the image on the platform door when the train or people mover is located remote from the station and (2) withhold back projecting the image when the train or people mover is located at the station.

The platform door can have touchscreen capability operative for detecting the presence and location of a touch on the platform door within a specified area of the image back projected on the platform door. The touchscreen capability can be coupled to the controller which can be operative for executing software code related to the location of the touch on the platform door.

The touchscreen capability can include the platform door having a circuit operative for generating an output related to the location of the touch on the platform door. The controller can be responsive to the output of the circuit for correlating the location of the touch on the platform door to the specified area of the image displayed on the platform door.

The touchscreen capability can include light emitters and light receivers operatively positioned about the platform door to form a light detection grid above the surface of the platform door. The controller can be responsive to a change in light received by at least one light receiver in response to the touch for correlating the location of the touch on the platform door to the specified area of the image displayed on the platform door.

### BRIEF DESCRIPTION OF THE DRAWINGS

FIG. 1 shows a series of platform doors disposed between a passenger platform side of a train or people mover station and a pathway of the train or people mover as viewed from the passenger platform side of a train or people mover station, where the pathway of the train or people mover is positioned on the other side of the platform doors;

FIG. 2 is an isolated view of the platform doors shown in FIG. 1 further illustrating that the two interior platform doors are moveable horizontally between opened and closed states and the outer two platform doors are fixed;

FIG. 3 is a perspective view of an image projector positioned on the pathway side of the platform doors of FIG. 1 illustrating the back projection of an image on the moveable platform doors of FIGS. 1 and 2;

FIG. 4 is a perspective view of the pathway shown in FIG. 3 including a train or people mover and showing the relation of the image projector of FIG. 3 with respect to the train or people mover;

FIG. 5 is an illustration of the platform doors of FIG. 1 from the passenger platform side showing the back projection of an image by the image projector on the moveable platform doors;

FIG. 6 is a view of the platform doors of FIG. 1 from the passenger platform side showing the back projection of an image on the left-most fixed platform door;

FIG. 7 is a perspective view of a number of platform doors (like the platform doors of FIG. 1) showing the back projection of an image on the left-most platform door;

FIG. 8 is an illustration of a platform door with touchscreen capability including an image projected thereon by the image projector shown in, e.g., FIG. 4, wherein, via the touchscreen capability, the presence and location of a touch on the platform door within a specified area of the image back projected on the platform door can be detected and a controller connected to the platform door can execute software code related to the presence and location of the touch, wherein the touchscreen capability includes the platform door including a circuit configured to generate an output related to the presence and location of the touch on the platform door; and

FIG. 9 is an illustration of the image on the platform door shown in FIG. 8, wherein the touchscreen capability includes light emitters and light receivers operatively positioned about the platform door to form a light detection grid above the surface of the platform door, wherein via the touchscreen capability, the presence and location of a touch on the platform door within the specified area of the image back projected on the platform door can be detected and the controller can execute software code related to the presence and location of the touch.

### DETAILED DESCRIPTION OF THE INVENTION

The present invention will be described with reference to the accompanying figures where like reference numbers correspond to like elements.

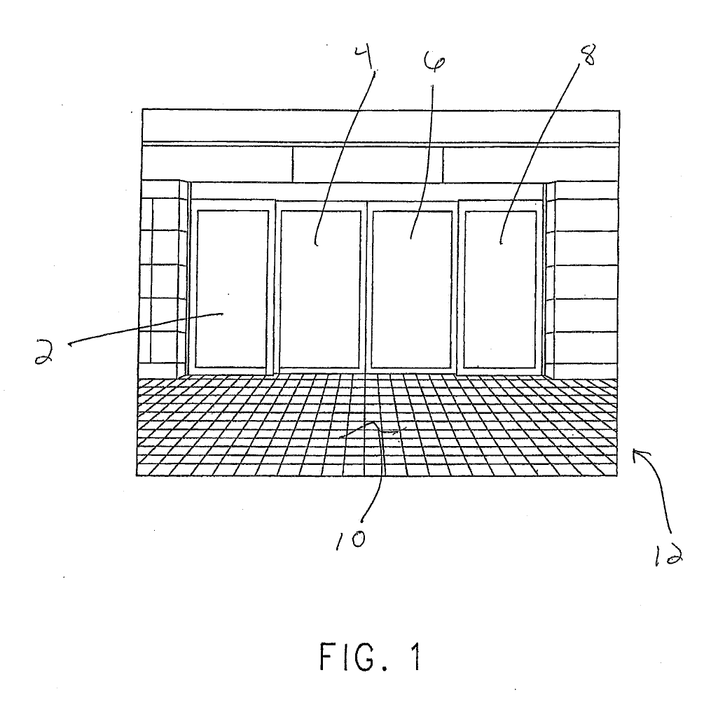

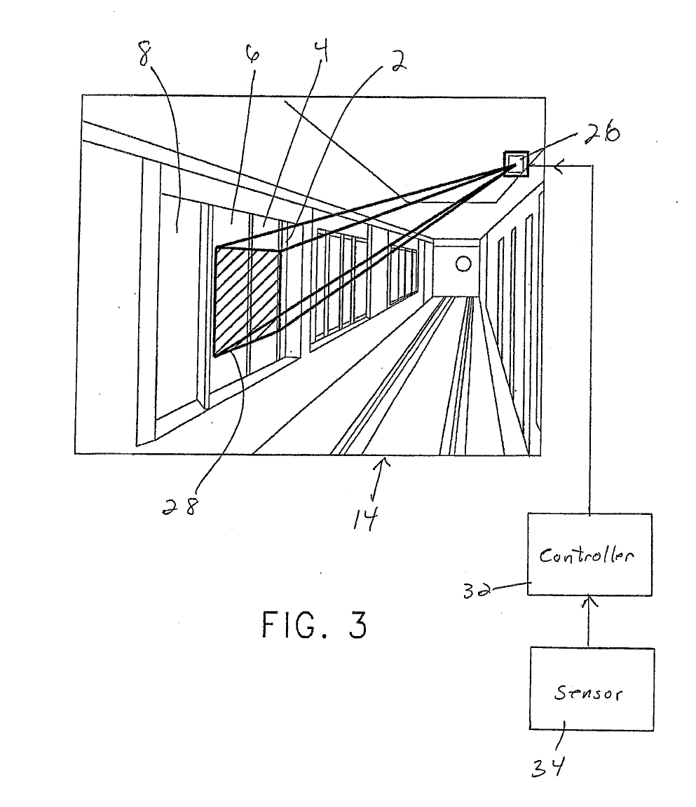

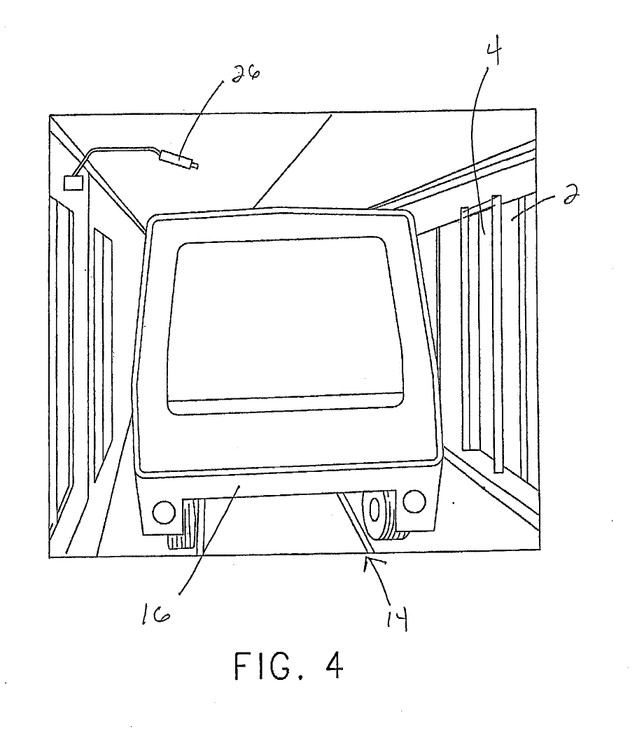

With reference to FIG. 1, the present invention will be described with reference to a number of platform doors 2, 4, 6, and 8 that are disposed between a passenger platform 10 of a train or people mover station 12 and a pathway 14 (FIG. 3) of the train or people mover 16 (FIG. 4).

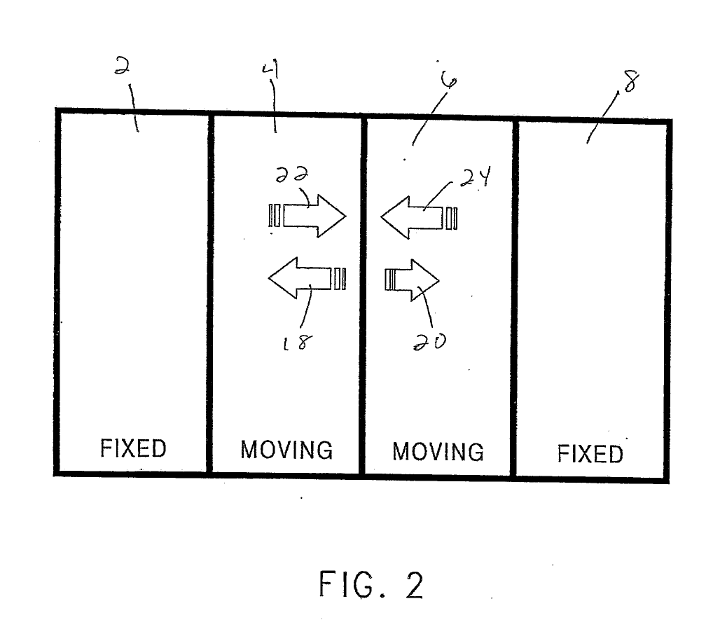

With reference to FIG. 2 and with continuing reference to FIG. 1, in the illustrated embodiment, platform doors 2 and 8 are fixed, immovable platform doors and platform doors 4 and 6 are moveable laterally (to an open state) in the direction of arrows 18 and 20 to allow passengers to move from platform 10 into train or people mover 16, or vice versa, and moveable laterally (to a closed state) in the direction of arrows 22 and 24 to block the movement of passengers between platform 10 and pathway 14 and/or the interior of train or people mover 16. The illustration and discussion herein of the present invention being utilized in connection with two fixed platform doors (2 and 8) and two laterally moveable platform doors (4 and 6) is not to be construed as limiting the invention since it is envisioned that the present invention can be utilized in connection with any number of platform doors, including one platform door, that are fixed and/or moveable in any suitable and/or desirable direction or manner between platform 10 and pathway 14.

With reference to FIGS. 3 and 4, and with continuing reference to FIGS. 1 and 2, an image projector 26 is positioned on the pathway 14 side of platform doors 2-8 in a manner to project one or more images on one or more or all of platform doors 2-8. Image projectors suitable for use in the present invention are well known in the art and will not be described herein.

In the embodiment illustrated in FIGS. 3 and 4, image projector 26 is positioned on a side of pathway 14 opposite platform doors 2-8 and above the highest level of platform doors 2-8. However, the vertical position of image projector 26 shown in the figures is not to be construed as limiting the invention since it is envisioned that the vertical position of image projector 26 can be set in any suitable and/or desirable manner that avoids physical interference between image projector 26 and train or people mover 16 moving on pathway 14 while enabling image projector 26 to project one or more images 28 onto one or more or all of platform doors 2-8 at least when train or people mover 16 is not present between image projector 26 and platform doors 2-8.

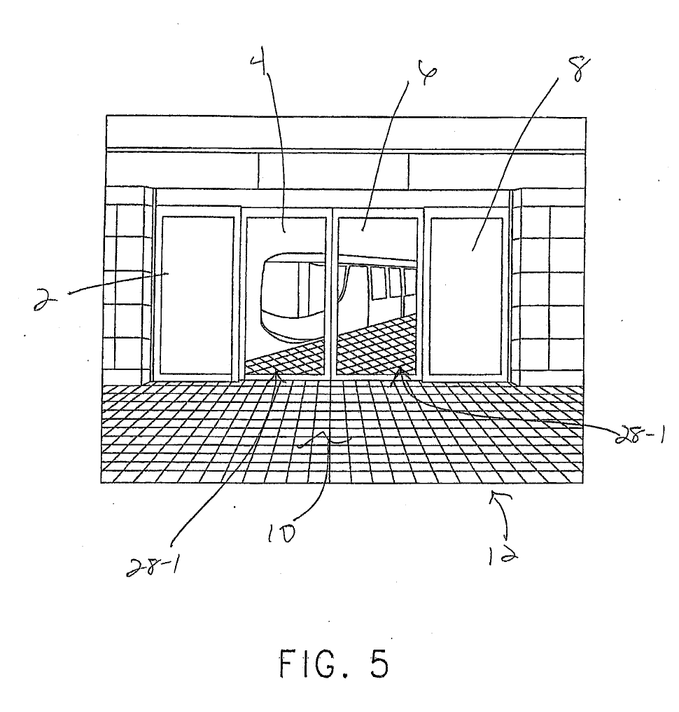

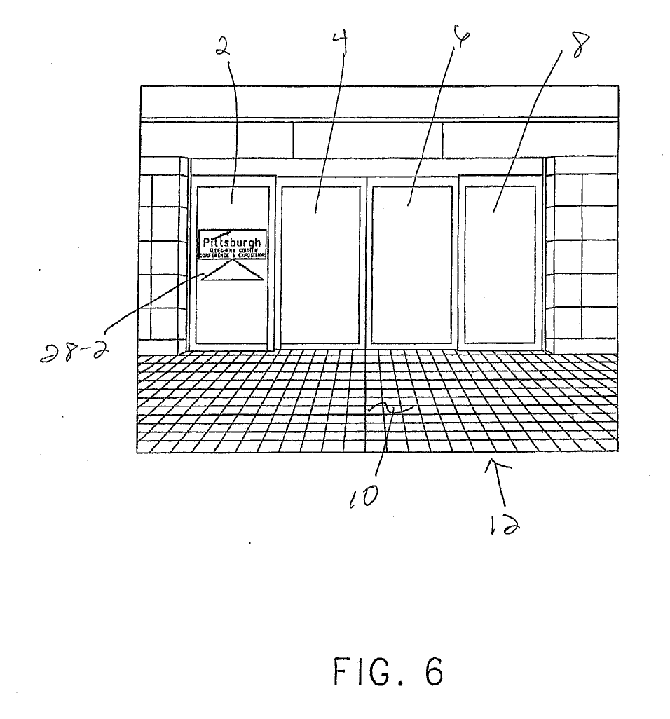

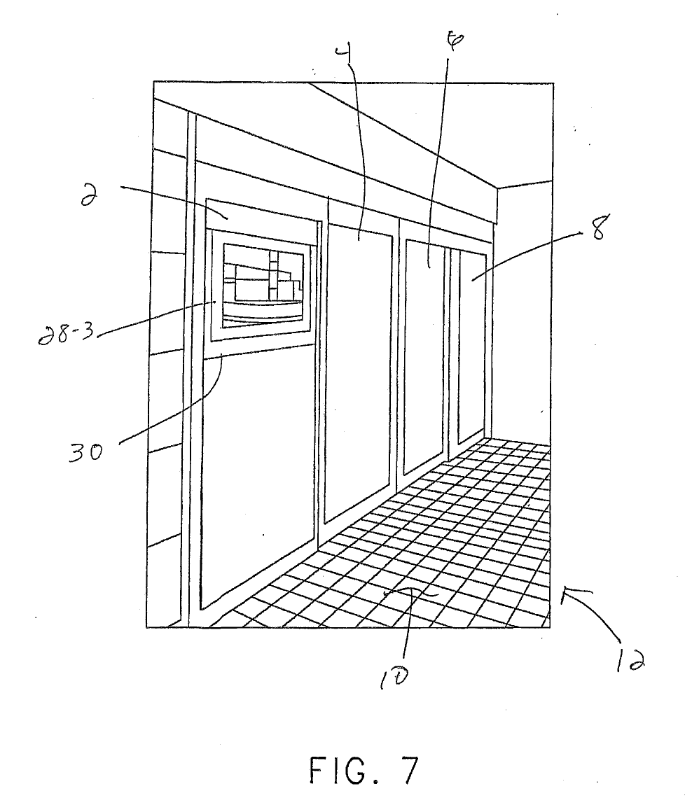

With reference to FIG. 5 and with continuing reference to FIGS. 1-4, image projector 26 is illustrated (in FIG. 5) as projecting image 28-1 on moveable platform doors 4 and 6. However, this is not to be construed as limiting the invention since image projector 26 can be positioned and operative for projecting an image on any number of platform doors 2-8, including a single platform door (like fixed platform door 2 as shown in FIGS. 6 and 7), two platform doors that are either next to each other, e.g., platform doors 4 and 6, or spaced apart, e.g., platform doors 2 and 8 (with platform doors 4 and 6 not having an image(s) projected thereon), or all of said platform doors 2-8. Accordingly, the illustration of image projector 26 projecting an image on moveable platform doors 4 and 6 in FIG. 3 or on fixed platform door 2 in FIGS. 6 and 7 is not to be construed as limiting the invention. In FIGS. 5-7, three different images 28-1, 28-2, and 28-3 are shown for the purpose of illustration and are not to be construed as limiting the invention. Moreover, the discussion herein of a single image projector 26 is not to be construed as limiting the invention since it is envisioned that two or more image projectors (like image projector 26) can be utilized to project any number of images on one or more or all of platform doors 2-8.

A method of image display on one or more of platform doors 2-8 of passenger platform 10 of a train or people mover station 12 will now be described. In the method, an image projector 26 is provided and positioned to back project a first image 28 on one or more platform doors, e.g., platform door 2, platform door 4, platform door 6, platform door 8, or some combination thereof, disposed between passenger platform 10 and pathway 14. In accordance with the present invention, image projector 26 is positioned on pathway 14 side of said one or more platform doors. At a suitable time, image projector 26 is caused to back project the first image 28 on said one or more platform doors.

Desirably, at least part of each platform door on which the first image is back projected is clear, opaque, or switchable between clear and opaque. To facilitate the part of each platform door where the first image is back projected to be switched between clear and opaque, said platform door can be layered or embedded with a suitable liquid crystal thin film laminate that can be switched between a clear state and an opaque state in response to the application or removal of an electrical bias to said film laminate. One suitable thin film laminate is available from iGlass of Mt. Helen, VIC 3353, Australia under the trade name iGlass.

The ability to switch the part of each platform door on which the image is back projected between clear and opaque enables the platform door to be switched to the opaque state for back projection of the image on the platform door and to be switched to a clear state when it is desired to provide an unimpeded view through the platform door, e.g., during passenger ingress or egress to or from train or people mover 16.

Desirably, each platform door 2-8 where an image is to be back projected by image projector 26 includes a suitable rear projection film to improve the contrast and color of the projected image. One suitable rear projection film is available from Minnesota Mining and Manufacturing Company, d.b.a. 3M Corporation, St. Paul, Minn., USA under the trademark VIKUITI®. VIKUITI® is a registered trademark of 3M Corporation. The disclosure herein of the thin film laminate and the rear projection film, however, are not to be construed as limiting the invention since it is envisioned that the use of either one or both of these films is optional.

It is envisioned that image projector 26 can project a single image or a series of images, including a motion picture, under the control of a controller 32 (FIG. 3). Controller 32 can be any suitable and/or desirable controller, such as, without limitation, a PC, that is capable of providing one image, a series of discrete images, or a series of images in the form of a motion picture to image projector 26 in any suitable and/or desirable image format, e.g., without limitation, JPEP, TIFF, etc.

In one embodiment, image projector 26 is positioned such that movement of train or people mover 16 on pathway 14 between image projector 26 and the one or more platform doors 2-8 blocks the back projection of the first image 28 on said one or more platform doors 2-8.

In another embodiment, the first image output by image projector 26 can be synchronized to a location of train or people mover 16 relative to station 12. More specifically, a train or people mover presence sensor 34 (FIG. 3) can be positioned at any suitable and/or desirable location on or along the length of pathway 14 to detect when train or people mover 16 is remote from station 12 or is located at station 12. Sensor 34 can be coupled to controller 32 which can then control the operation of image projector 26 to back project one or more image(s) on the one or more platform doors 2-8 when train or people mover 16 is located remote from station 12. Similarly, in response to output of sensor 34, controller 32 can control image projector 26 to withhold back projecting one or more image(s) when train or people mover 16 is located at station 12. In this manner, image projector 26 can back project first image 28 in the absence of train or people mover 16 at station 12. In response to movement of the train or people mover 16 toward or into station 12, controller 32, in response to the output of sensor 34 indicating the presence of train or people mover 16 moving toward or into station 12, can terminate image projector 26 back projecting first image 28. Similarly, in response to controller receiving from sensor 34 an indication of movement of the train or people mover 16 away from station 12, controller 32 can commence image projector 26 back projecting first image 28 (or a second image) on the one or more platform doors 2-8.

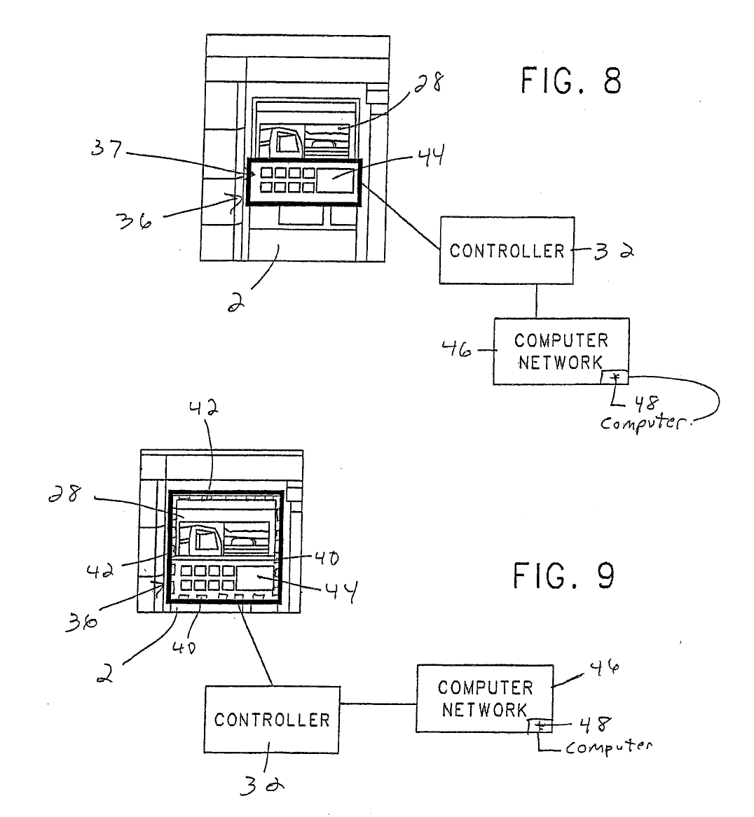

With reference to FIG. 8 and with continuing reference to FIGS. 1-7, each platform door 2-8 that receives an image from image projector 26 can optionally include any suitable or desirable form of touchscreen capability 36. This touchscreen capability 36 will be described with reference to said touchscreen capability 36 being available on platform door 2. However, this is not to be construed as limiting the invention since any one or some or all of platform doors 2-8 can include touchscreen capability as deemed suitable and/or desirable.

Touchscreen capability 36 can be provided by any one or number of touchscreen technologies presently known in the art or hereinafter developed. Examples of suitable touchscreen technologies include: capacitive, resistive, surface acoustic wave, strain gauge, piezoelectric, and dispersive signal. This listing of suitable touchscreen technologies, however, is not to be construed as limiting the invention. Since these touchscreen technologies are well known in the art, details regarding each technology will not be disclosed herein.

Each of these touchscreen technologies and the touchscreen capability 36 provided thereby is provided by a suitable circuit 37 formed on platform door 2 in any suitable or desirable manner. Circuit 37 is comprised of one or a pattern of conductors and, optionally, signal processing technology (integrated circuits) known in the art. The output of the touchscreen capability 36 provided on platform door 2 is supplied to controller 32 which is programmed to be responsive to said output. Via the touchscreen capability 36, the presence and location of a touch on platform door 2 within a specified area of the first image 28 being back projected on platform door 2 by image projector 26 can be detected. Controller 32 can be programmed to be responsive to the output of the touchscreen capability 36 in response to the touch on platform door 2 for correlating the location of the touch on platform door 2 to the specified area of the image 28 being displayed on platform door 2 and for executing software code related to the location of said touch in the specified area of the image 28.

With reference to FIG. 9, and with continuing reference to FIGS. 1-8, in another embodiment, touchscreen capability 36 can be provided by an infrared (IR) bezel system 38 that includes light emitters 40 and light receivers 42 operatively positioned about the platform door to form an infrared grid above the surface of platform door 2 where image 28 is displayed. At least the light receivers 42 are coupled to controller 32 which is programmed to be responsive to a change in light received by one or more of said light receivers 42 in response to the presence and location of a touch on the platform door for correlating the location of the touch on the platform door to the specified area of image 28 being displayed on platform door 2.

By way of the touchscreen capability provided by circuit 37 or IR bezel system 38, controller 32 can assign software code segments to sections of an image, e.g., image 28, being back projected onto platform door 2 by image projector 28, whereupon in response to detecting the presence and location of a touch on a specific area, e.g., area 44, of image 28 back projected on platform door 2, controller 32 executes the software code segment associated with said area 44.

By way of touchscreen capability 36, controller 32, and image projector 26, a passenger waiting to board train or people mover 16 can perform a transaction with a vendor at another stop of train or people mover 16, request information to be displayed by image projector 26, such as a map, gate information, ground transportation, arrival/departure information, etc.; or any other suitable and/or desirable electronic transaction that can be facilitated by controller 32 standing alone or in communication with one or more other computers 48 via a computer network 46.

The following are some non-limiting examples of the use of touchscreen capability 36, controller 32, and image projector 26.

### EXAMPLE 1

At a station 12 within an airport, a passenger utilizes touchscreen capability 36 to determine the route to a desired gate/baggage claim area by entering in a flight number and choosing an appropriate selection being displayed on one or more platform doors 2-8: (a) route to gate; or (b) baggage claim. Upon touching the appropriate selection, controller 32 executes software code that provides the information. The information that may be provided can include:

(1) a display by image projector 26 of the map and route to the required gate/baggage claim on one or more of platform doors 2-8;

(2) dispatch of the information as text or a multimedia visual display on the passenger's cellular phone;

(3) a physical printout of the desired information (route, position, etc.) on a printer (not shown) positioned near the one or more of platform doors 2-8.

### EXAMPLE 2

Example 1 may be used in an urban setting to provide users with directions for travel to a specific destination.

### EXAMPLE 3

At one station, a passenger may use the touchscreen capability 36 to order one or more items, such as a snack or coffee, from a vendor via computer 48 which resides at another station where the passenger wants to depart the train or people mover 16. The payment may be made via cash or via known electronic means (credit cards, smart cards, special means, etc.).

In example 3, the system may provide a confirmation (with a confirmation code as a text or as a bar code) to the merchant as well as to the passenger. Knowing the time of arrival of the train at a station (the passenger can choose the train or people mover 16 he desires to take), the merchant at the destination station may time the preparation of the ordered item(s) such that it is fresh and ready for pickup when the passenger reaches the destination and the passenger desirably provides the text/bar code confirmation to the merchant.

Still other ways of providing e-commerce is envisioned.

It is envisioned that computer network 46 can be comprised of any suitable and/or desirable combination of hardware and software, such as, without limitation, servers, routers, switches, and other controllers, e.g., in the form of PCs. Hence, it is intended that computer network 46 be construed broadly as comprising any suitable and/or desirable combination of hardware that facilitates electronic communication and commerce in the manner described above.

The present invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of image display on one or more platform doors of a passenger platform of a train or people mover station, the method comprising:
(a) providing an image projector positioned to project a first image on one or more platform doors disposed between a passenger platform of a train or people mover station and a pathway of the train or people mover, wherein the image projector is positioned on the pathway side of the one or more platform doors; and
(b) causing the image projector to back project the first image on the one or more platform doors.

2. The method of claim 1, wherein at least a part of each platform door where the first image is back projected is clear, opaque, or is switchable between clear and opaque.

3. The method of claim 1, wherein the first image is either a single image or one image of a plurality of images.

4. The method of claim 1, wherein step (a) includes positioning the image projector such that movement of the train or people mover on the pathway between the image projector and the one or more platform doors blocks the back projection of the first image on the one or more platform doors.

5. The method of claim 1, further including synchronizing the image projector to a location of the train or people mover relative to the station, whereupon:
the image projector back projects the first image on the one or more platform doors when the train or people mover is located remote from the station; and
the image projector withholds back projecting the first image when the train or people mover is located at the station.

6. The method of claim 1, wherein:
in step (b) the image projector back projects the first image in the absence of the train or people mover at the station; and the method further includes
(c) in response to movement of the train or people mover toward the station, terminating the image projector back projecting the first image; and
(d) in response to movement of the train or people mover away from the station, commencing the image projector back projecting either the first image or a second image on the one or more platform doors.

7. The method of claim 1, further including:
(c) providing at least one of the one or more platform doors with touchscreen capability;
(d) via the touchscreen capability, detecting the presence and location of a touch on the platform door within a specified area of the first image back projected on the platform door; and
(e) executing software code related to the location of the touch in step (d).

8. The method of claim 7, wherein the touchscreen capability includes:
the platform door including a circuit configured to generate an output related to a location of the touch on the platform door; and
a controller responsive to the output of the circuit in response to the touch for correlating the location of the touch on the platform door to the specified area of the image displayed on the platform door.

9. The method of claim 8, wherein the circuit implements one of the following touchscreen technologies: capacitive, resistive, surface acoustic wave, strain gauge, piezoelectric, and dispersive signal.

10. The method of claim 7, wherein the touchscreen capability includes:
light emitters and light receivers operatively positioned about the platform door to form a light detection grid above a surface of the platform door; and
a controller programmed to be responsive to a change in light received by at least one light receiver in response to the touch for correlating the location of the touch on the platform door to the specified area of the image displayed on the platform door.

11. The method of claim 10, wherein the light emitters output infrared light and the light receivers are infrared light receivers.

12. A method of image display on a platform door that separates a passenger platform of a train or people mover station from a pathway of the train or people mover, the method comprising:
(a) positioning an image projector to project an image toward a platform door disposed between a passenger platform of a train or people mover station and a pathway of the train or people mover, wherein the image projector is positioned on the pathway side of the platform door;
(b) coupling to the image projector a controller that is programmed to cause the image projector to back project the image toward the platform door; and
(c) providing an input to the controller which is responsive to a signal produced via the input for executing the program to cause the image projector to back project the image toward the platform door.

13. The method of claim 12, wherein at least a part of each platform door where the image is back projected toward is clear, opaque, or is switchable between clear and opaque.

14. The method of claim 12, wherein in step (a) the image projector is positioned such that movement of the train or people mover on the pathway between the image projector and the platform door causes the back projected image to fall on the train or people mover.

15. The method of claim 12, further including synchronizing the image projector to a location of the train or people mover relative to the station, whereupon:
the image projector back projects the image on the platform door when the train or people mover is located remote from the station; and
the image projector withholds back projecting the image when the train or people mover is located at the station.

16. The method of claim 12, further including:
(d) providing the platform door with touchscreen capability;
(e) via the touchscreen capability, detecting the presence and location of a touch on the platform door within a specified area of the image back projected on the platform door; and
(f) executing software code related to the location of the touch in step (e).

17. The method of claim 7, wherein the touchscreen capability includes:
the platform door including a circuit operative for generating an output related to a location of the touch on the platform door; and
a controller responsive to the output of the circuit in response to the touch for correlating the location of the touch on the platform door to the specified area of the image displayed on the platform door.

18. The method of claim 7, wherein the touchscreen capability includes:
light emitters and light receivers operatively positioned about the platform door to form a light detection grid above the surface of the platform door; and
the controller programmed to be responsive to a change in light received by at least one light receiver in response to the touch for correlating the location of the touch on the platform door to the specified area of the image displayed on the platform door.

19. An image display system comprising, in combination:
a platform door separating a passenger platform of a train or people mover station from a pathway of the train or people mover;
an image projector positioned on the pathway side of the platform door to project an image toward the platform door; and
a controller programmed to cause the image projector to back project the image toward the platform door.

20. The image display system of claim 19, wherein the controller is responsive to an input signal for executing the program to cause the image projector to back project the image toward the platform door.

21. The image display system of claim 19, wherein at least a part of each platform door where the image is back projected toward is clear, opaque, or is switchable between clear and opaque.

22. The image display system of claim 19, wherein the image projector is positioned whereupon movement of the train or people mover on the pathway between the image projector and the platform door blocks the back projection of the image on the platform door.

23. The image display system of claim 19, further including a presence sensor coupled to the controller and operatively positioned to detect the presence or absence of the train or people mover at the station, wherein the controller is response to an output of the presence sensor for causing the image projector to (1) back project the image on the platform door when the train or people mover is located remote from the station and (2) withhold back projecting the image when the train or people mover is located at the station.

24. The image display system of claim 19, further including the platform door having touchscreen capability operative for detecting the presence and location of a touch on the platform door within a specified area of the image back projected on the platform door, said touchscreen capability coupled to the controller which is operative for executing software code related to the location of the touch on the platform door.

25. The image display system of claim 24, wherein:
the touchscreen capability includes the platform door having a circuit operative for generating an output related to the location of the touch on the platform door; and
the controller is responsive to the output of the circuit for correlating the location of the touch on the platform door to the specified area of the image displayed on the platform door.

26. The image display system of claim 24, wherein:
the touchscreen capability includes light emitters and light receivers operatively positioned about the platform door to form a light detection grid above the surface of the platform door; and
the controller is responsive to a change in light received by at least one light receiver in response to the touch for correlating the location of the touch on the platform door to the specified area of the image displayed on the platform door.
